(19) United States
(12) Patent Application Publication
(10) Pub. No.: US 2026/0203164 A1
(43) Pub. Date: Jul. 16, 2026

(54) ERROR CORRECTION CODE COVERAGE EXTENSION IN A MEMORY SYSTEM

(71) Applicant: Micron Technology, Inc., Boise, ID (US)

(72) Inventors: Su Wei Lim, Penang (MY); Marco Sforzin, Cernusco Sul Naviglio (MI) (IT)

(21) Appl. No.: 19/431,768

(22) Filed: Dec. 23, 2025

Related U.S. Application Data
(60) Provisional application No. 63/744,117, filed on Jan. 10, 2025.

(51) Int. Cl. G06F 11/10

(52) U.S. Cl. CPC G06F 11/1044

(57) ABSTRACT

Methods, systems, and devices for error correction code (ECC) coverage extension in a memory system are described. In a first technique, the memory system may correct, using a first ECC scheme, data bits read from a first memory die that has failed, the data bits included in a first codeword protected by the first ECC scheme. The memory system may generate, using a second ECC scheme and after correcting the data bits using the first ECC scheme, a second codeword that includes the data bits based on the memory system having a threshold quantity of failed memory dies. The memory system may write the data bits of the second codeword to a second memory die previously used to store parity bits for the first codeword.

### CROSS REFERENCE

The present Application for Patent claims priority to U.S. Patent Application No. 63/744,117 by Lim et al., entitled “ERROR CORRECTION CODE COVERAGE EXTENSION IN A MEMORY SYSTEM,” filed January 10, 2025, which is assigned to the assignee hereof, and which is expressly incorporated by reference in its entirety herein.

### TECHNICAL FIELD

The following relates to one or more systems for memory, including error correction code (ECC) coverage extension in a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports ECC coverage extension in a memory system in accordance with examples as disclosed herein.

FIG. 2 shows examples of codeword storage configurations that support ECC coverage extension in a memory system in accordance with examples as disclosed herein.

FIG. 3 shows an example of a codeword storage configuration that supports ECC coverage extension in a memory system in accordance with examples as disclosed herein.

FIG. 4 shows an example of a codeword storage configuration that supports ECC coverage extension in a memory system in accordance with examples as disclosed herein.

FIG. 5 shows an example of a process flow that supports ECC coverage extension in a memory system in accordance with examples as disclosed herein.

FIG. 6 shows an example of memory dies that support ECC coverage extension in a memory system in accordance with examples as disclosed herein.

FIG. 7 shows an example of a process flow that supports ECC coverage extension in a memory system in accordance with examples as disclosed herein.

FIG. 8 shows a block diagram of a memory system that supports ECC coverage extension in a memory system in accordance with examples as disclosed herein.

FIGS. 9 and 10 show flowcharts illustrating a method or methods that support ECC coverage extension in a memory system in accordance with examples as disclosed herein.

### DETAILED DESCRIPTION

A memory system that includes multiple memory dies may employ an advanced error correction (ECC) scheme, also known as a codeword-level ECC scheme, to enable correction of codewords that arise from the failure of a memory die. For example, a memory system may use a Single Die Data Correction (SDDC) ECC scheme that enables correction for a single-die failure, a Dual Die Data Correction (DDDC) ECC scheme that enables correction for a two-die failure, or a Quad Die Data Correction (QDDC) ECC scheme that enables correction for a four-die failure, among other various examples. If the quantity of die-level failures in a memory system exceeds the quantity correctable by the codeword-level ECC scheme implemented by the memory system, the memory system may fail.

Using the techniques described herein, a memory system with a codeword-level ECC scheme may increase the quantity of die-failures that the memory system is capable of correcting (referred to as ECC coverage) past the quantity supported by the codeword-level ECC scheme alone. For example, if the memory system employs a codeword-level ECC scheme capable of correcting x die-level failures, the techniques described herein may allow the memory system to correct at least x+m die-level failures unlike other different techniques which may be capable of correcting x or fewer than x die-level failures.

In a first technique, the memory system may use a first codeword-level ECC scheme to correct failed memory dies until the first codeword-level ECC scheme is exhausted (e.g., incapable of correcting for additional die-level failures), at which point the memory system may switch to a lower-power ECC scheme by re-purposing one or more parity dies (e.g., dies used to store parity bits for the first codeword-level ECC scheme) into data dies (e.g., dies used to store data bits). For example, if the memory system employs a DDDC ECC scheme, the memory system may 1) detect when a threshold quantity of memory dies (e.g., two memory dies) involved in the storage of a codeword have failed, and 2) correct the data bits in the codeword using the DDDC ECC scheme. The memory system may then generate a new codeword from the corrected data bits using a SDDC ECC scheme and store the data bits of the failing memory die(s) (e.g., including the corrected data bits of the new codeword) in memory dies that were previously used to store the parity bits for the DDDC ECC scheme. So, the failing die(s) are effectively replaced by the memory die previously used to store parity. Since The SDDC ECC scheme consumes two parity memory dies (as opposed to the four consumed by the DDDC ECC scheme), using a lower-power ECC scheme to protect the data frees up two memory dies for data bits. The failed memory die(s) are no longer used moving forward and instead the memory die(s) that replace the failing memory die(s) are used instead. Thus, the memory system may be capable of correcting a third memory die failure (e.g., using the SDDC ECC scheme), even though the highest-power ECC scheme configured for the memory system is a DDDC ECC scheme.

In a second technique, the memory system may detect when a threshold quantity of memory dies have failed (e.g., a quantity equal to the coverage of the codeword-level ECC scheme) and copy the data from the failed memory dies to replacement memory dies. Before doing so, the memory system may correct the data from the failed memory dies using the codeword-level ECC scheme. For example, if the memory system employs a SDDC ECC scheme and the memory system detects that a memory die has failed, the memory system may correct the data from the failed memory die and write it to a replacement memory die. The memory system may continue such a practice until the memory system has used a threshold quantity (e.g., all) of the replacement memory dies. Thus, the memory system may be capable of correcting multiple memory die failures even though the memory system is configured with a SDDC ECC scheme.

In addition to applicability in memory systems as described herein, techniques for extending codeword-level ECC coverage may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by extending the life of electronic devices, thereby reducing electronic waste), among other benefits.

Features of the disclosure are illustrated and described in the context of systems and architectures. Features of the disclosure are further illustrated and described in the context of storage configurations, process flows, and flowcharts.

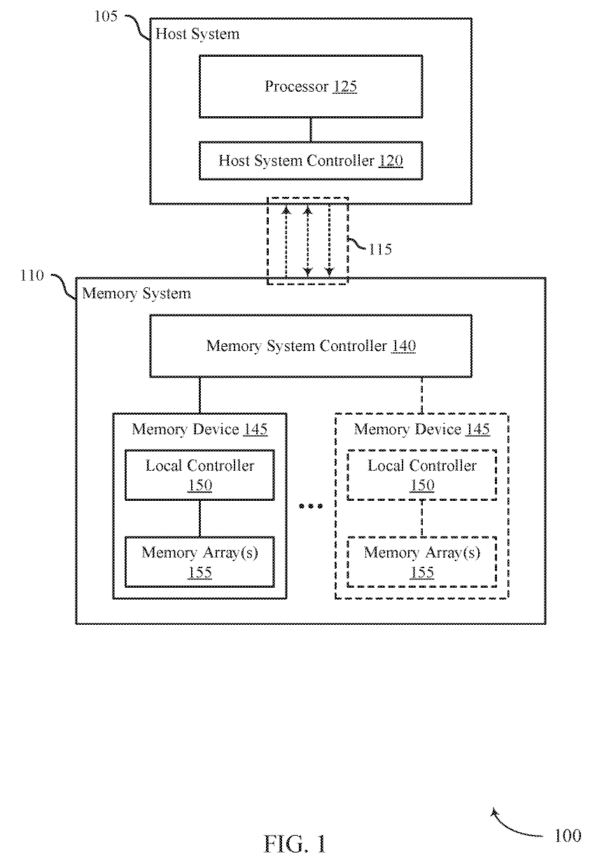

FIG. 1 shows an example of a system 100 that supports ECC coverage extension in a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples, the memory system 110 may employ a codeword-level ECC scheme (e.g., a Reed Solomon ECC algorithm) (also referred to as a codeword-level ECC algorithm, a die-level ECC scheme) that enables correction of errors that arise from die-level failures (e.g., errors in a codeword that are due to one or more failed memory dies). To support correction of a codeword generated using the codeword-level ECC scheme, the memory system 110 may store the codeword across multiple memory dies. For example, the data bits of the codeword may be stored across a first set of memory dies and the parity bits of the codeword may be stored across a second set of memory dies. In general, higher-power codeword-level ECC schemes (e.g., codeword-level ECC schemes that correct higher quantities of die-level failures) may protect larger quantities of data and involve larger quantities of parity bits relative to lower-power codeword-level ECC schemes. However, higher power codeword-level ECC schemes are associated with higher processing complexity and higher overhead (e.g., larger quantities of parity bits).

The codeword-level ECC scheme employed by the memory system 110 may have a limit on the number of die-level failures it can correct. According to the techniques described herein, the memory system 110 may increase—past the limit of the codeword-level ECC scheme—the number of die-level failures it can correct, thus extending the life of the memory system 110.

In the first technique, the memory system 110 may increase ECC coverage by re-protecting (e.g., re-encoding) the data of one or more failed memory die(s) using a lower power codeword-level ECC scheme after correcting the data using a higher power codeword-level ECC scheme. To accommodate the re-protected data even though the failed memory die(s) are no longer viable, the memory system 110 may re-purpose a subset of the dies previously used to store parity bits for the higher power codeword-level ECC scheme so that the subset of dies stores the data previously stored in the failed dies.

In the second technique, the memory system 110 may increase ECC coverage by using replacement memory dies to store corrected data from failed memory dies. For example, upon detecting one or more failed memory die(s), the memory system 110 may correct the data stored by the memory die(s) (e.g., using a codeword-level ECC scheme) and write the corrected data to one or more replacement memory die(s). So, the quantity of failed memory dies corrected using the second technique may exceed the quantity of die-level failures that are correctable by use of the codeword-level ECC scheme alone.

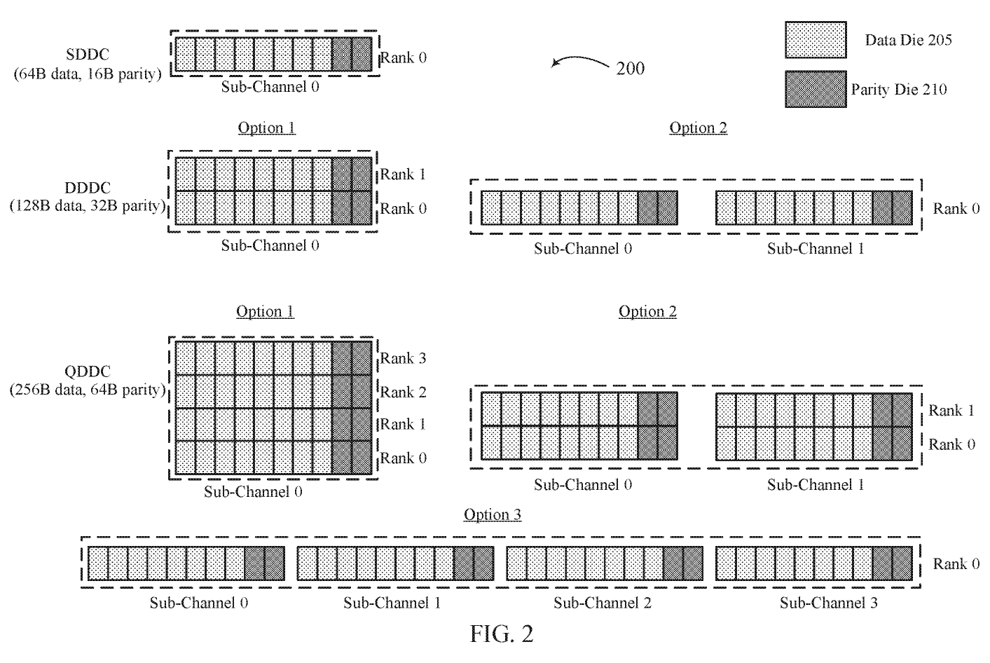

FIG. 2 illustrates examples of codeword storage configurations 200 that support ECC coverage extension in a memory system in accordance with examples as disclosed herein. The memory system may be an example of the memory system 110 as described with reference to FIG. 1. The memory system may include data dies 205, which may be selected for storing data (e.g., user data), and parity dies 210, which may be selected for storing parity bits for a codeword-level ECC scheme. The memory dies may be grouped into sub-channels (e.g., four sub-channels), which may be controlled by respective memory controllers, and ranks (e.g., rank 0 though rank 3).

The memory system may store a codeword in the memory dies as described herein, where the memory dies used to store the codeword are indicated by the dashed boxes. However, any quantity of codewords may be stored in the memory dies.

If the memory system is configured with a SDDC ECC scheme, the memory system may store a codeword (e.g., made up of 64B data bits and 16B parity bits) in the memory dies of rank 0 in sub-channel 0. If the memory system is configured with a DDDC ECC scheme, the memory system may store a codeword (e.g., made up of 128B data bits and 32B parity bits) in the memory dies of rank 0 and rank 1 in sub-channel 0 (e.g., Option 1) or in the memory dies of the same rank (e.g., rank 0) in sub-channel 0 and sub-channel 1 (e.g., Option 2), in which case the memory controllers of sub-channel 0 and sub-channel 1 may operate in lock-step.

If the memory system is configured with a QDDC ECC scheme, the memory system may, in first option (e.g., Option 1), store a codeword (e.g., made up of 256B data bits and 64B parity bits) in the memory dies of rank 0 through rank 3 in sub-channel 0. In a second option (e.g., Option 2), the memory system may store the codeword in the memory dies of rank 0 and rank 1 in sub-channel 0 and sub-channel 1, in which case the memory controllers of sub-channel 0 and sub-channel 1 may operate in lock-step. In a third option (e.g., Option 3), the memory system may store the codeword in the memory dies of rank 0 in sub-channel 0 through sub-channel 3, in which case the memory controllers of sub-channel 0, sub-channel 1, sub-channel 2, and sub-channel 3 may operate in lock-step.

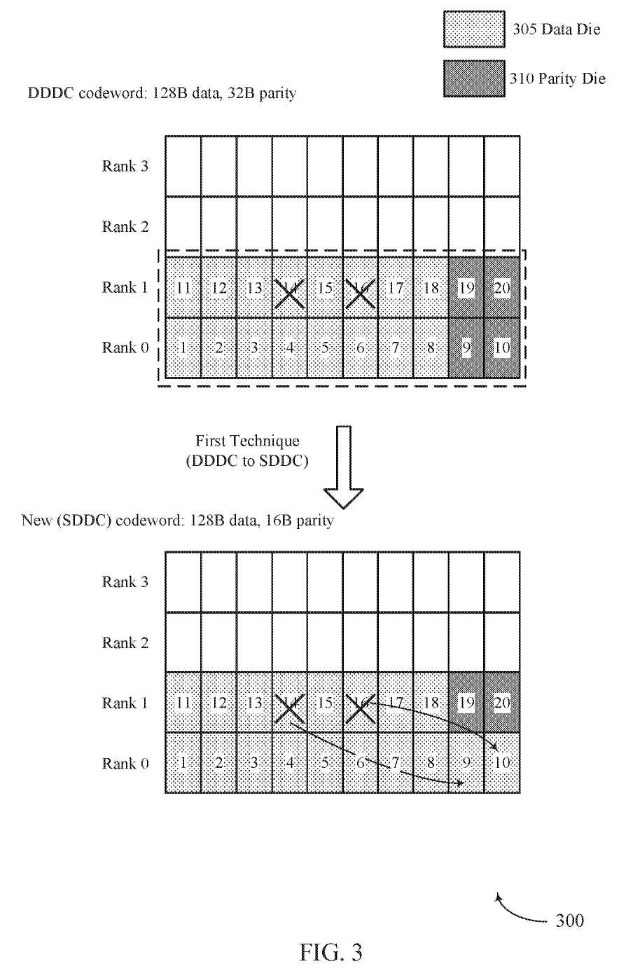

So, different codeword-level ECC schemes may be associated with different quantities of data bits and parity bits, with higher-power codeword-level ECC schemes being associated with larger quantities of data bits and parity bits relative to lower-power codeword-level ECC schemes. Further, different codeword-level ECC scheme may use different storage configurations for codewords. Any of the storage configurations illustrated in FIG. 3 may be used with the techniques described herein, but the techniques described herein are not limited to the illustrated storage configurations

FIG. 3 shows an example of a codeword storage configuration 300 that supports ECC coverage extension in a memory system in accordance with examples as disclosed herein. The storage configuration 300 may be an example of a DDDC storage configuration (e.g., DDDC storage configuration Option 1) for a codeword, such as a codeword that includes 128B of data and 32B of parity. The storage configuration may support use of the first technique by a memory system such as the memory system 110 as described with reference to FIG. 1. The first technique may allow the memory system 110 to correct three die-level failures even though the memory system is configured with a DDDC ECC scheme.

The codeword may initially be stored in the memory dies (e.g., die 1 through die 20) outlined by the dashed box. For example, the data bits of the codeword may be stored in the data dies 305 (e.g., die 1 through die 8 and die 11 through die 18) and the parity bits of the codeword may be stored in the parity dies 310 (e.g., dies 9, 10, 19, and 20). Before storing the codeword, the memory system may generate the codeword using a first codeword-level ECC scheme (e.g., the DDDC ECC scheme). Thus, the parity bits of the codeword may be generated using the first codeword-level ECC scheme and may be based on the data bits. In the given DDDC ECC scheme example, the codeword may include 128B of data and 32B of parity, and so the data bits of the codeword may be stored across sixteen memory dies and the parity bits of the codeword may be stored across four memory dies.

After determining that a threshold quantity of memory dies (e.g., two memory dies such as die 14 and die 16) have failed, the memory system may use the first codeword-level ECC scheme (e.g., the DDDC ECC scheme) to correct the data bits of the codeword that are stored in the failed memory dies. To do so, the memory system may read the data bits of the codeword from the data memory dies 305, including the failed memory dies (e.g., die 14, die 16), read the parity bits of the codeword from the parity dies 310, and apply the first codeword-level ECC scheme. The memory system may then perform the first technique. So, a trigger for performing the first technique may be the determination that a threshold quantity of memory dies have failed, where the threshold quantity of memory dies may be equal to the quantity of memory dies the first codeword-level ECC scheme is capable of correcting. The memory system may detect that a memory die has failed based on the memory die having a threshold error metric.

As part of the first technique, and after correcting the data bits of the codeword, the memory system may generate a new codeword (that includes the data bits) using a second codeword-level ECC scheme that is lower-powered than the first codeword-level ECC scheme (e.g., capable of correcting fewer die-level failures). For example, the memory system may apply a SDDC ECC scheme to the data bits to generate new parity bits that, together with the data bits, form the new (SDDC-protected) codeword. Because the SDDC ECC is lower-powered than the DDDC ECC scheme, the quantity of new parity bits (e.g., 16B) in the new codeword may be less the quantity of parity bits (e.g., 32B) in the original codeword (e.g., the codeword protected by the DDDC ECC scheme).

After generating the new codeword, the memory system may store the new codeword in the memory dies. To accommodate the new codeword despite the failure (and thus unavailability) of die 14 and die 16, the memory system may re-purpose some of the parity dies 310 to be data dies 305. For example, the data bits of the new codeword (which were previously stored in die 14 and die 16) may be written to die 9 and die 10. Thus, die 9 and die 10 may “replace” die 14 and die 16 as the memory dies storing the data bits of the codeword. Although re-purposing die 9 and die 10 reduces the quantity of parity dies 310, the memory system still has capacity to store the parity bits for the new codeword because the quantity of new parity bits (e.g., 16B) associated with the SDDC ECC scheme is less than the quantity of parity bits (e.g., 32B) associated with the DDDC ECC scheme. So, the memory system may write the parity bits for the new codeword to die 19 and die 20. Accordingly, the data bits of the new codeword may be stored across sixteen memory dies and the parity bits of the codeword may be stored across two memory dies.

Because the new codeword is protected by the SDDC ECC scheme, the memory system is able to correct for another die-level failure, bringing the total quantity of die-level failure corrections to three. For example, if die 2 fails, the memory system may use the SDDC ECC scheme to correct the data bits of the codeword that are stored in die 2.

Thus, the first technique may enable ECC coverage extension by allowing the memory system to correct three die-level failures even though the memory system is configured with a DDDC ECC scheme.

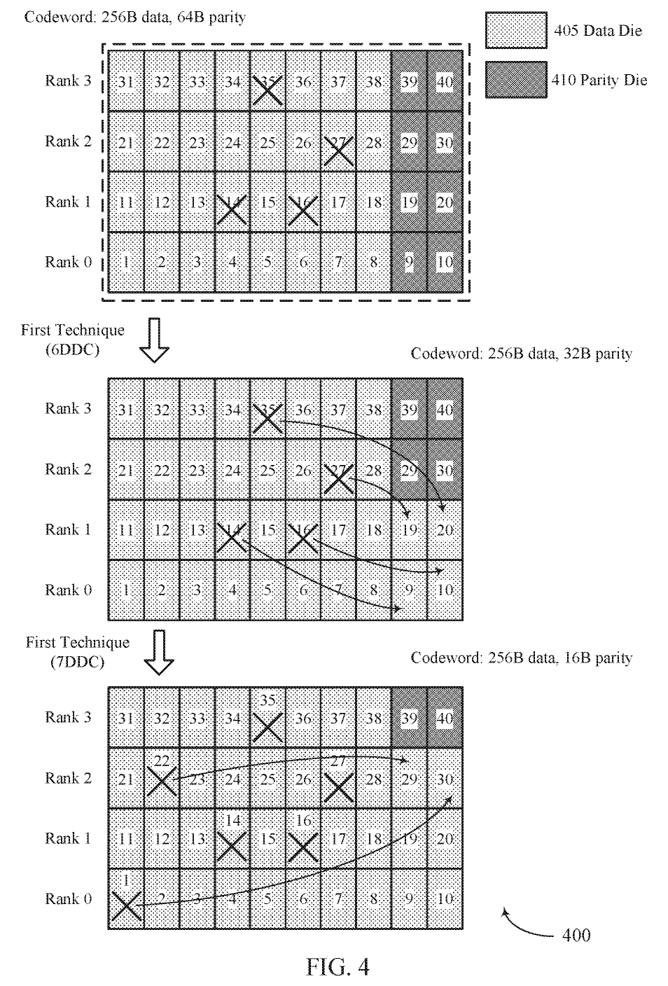

FIG. 4 shows an example of a codeword storage configuration 400 that supports ECC coverage extension in a memory system in accordance with examples as disclosed herein. The storage configuration 400 may be an example of a QDDC storage configuration (e.g., QDDC storage configuration Option 1) for a codeword, such as a codeword that includes 256B of data and 64B of parity. The storage configuration may support use of the first technique by a memory system such as the memory system 110 as described with reference to FIG. 1. The first technique may allow the memory system 110 to correct six die-level failures (or seven die-level failures) even though the memory system is configured with a QDDC ECC scheme.

The codeword may initially be stored in the memory dies (e.g., die 1 through die 40) outlined by the dashed box. For example, the data bits of the codeword may be stored in the data dies 305 (die 1 through die 8, die 11 through die 18, die 21 through die 28, and die 31 through die 38) and the parity bits of the codeword may be stored in the parity dies 310 (e.g., dies 9, 10, 19, 20, 29, 30, 39, and 40). Before storing the codeword, the memory system may generate the codeword using a first codeword-level ECC scheme (e.g., the QDDC ECC scheme). Thus, the parity bits of the codeword may be generated using the first codeword-level ECC scheme and may be based on the data bits. In the given QDDC ECC scheme example, the codeword may include 256B of data and 64B of parity, and so the data bits of the codeword may be stored across thirty-two memory dies and the parity bits of the codeword may be stored across eight memory dies.

After determining that a threshold quantity of memory dies (e.g., four dies such as die 14, die 16, die 27, and die 35) have failed, the memory system may use the first codeword-level ECC scheme (e.g., the QDDC ECC scheme) to correct the data bits of the codeword that are stored in the failed memory dies. To do so, the memory system may read the data bits of the codeword from the data memory dies 405, including the failed memory dies 405, read the parity bits of the codeword from the parity dies 410, and apply the first codeword-level ECC scheme. The memory system may then perform the first technique.

As part of the first technique, and after correcting the data bits of the codeword, the memory system may generate a new codeword (that includes the data bits) using a second codeword-level ECC scheme that is lower-powered than the first codeword-level ECC scheme. For example, the memory system may apply a DDDC ECC scheme to the data bits to generate new parity bits that, together with the data bits, form the new codeword. Because the DDDC ECC is lower-powered than the QDDC ECC scheme, the quantity of new parity bits (e.g., 32B) in the new (DDDC-protected) codeword may be less the quantity of parity bits (e.g., 64B) in the original (QDDC-protected) codeword.

After generating the new codeword, the memory system may store the new codeword in the memory dies. To accommodate the new codeword despite the failure of die 14, die 16, die 27, and die 35, the memory system may re-purpose some of the parity dies 410 to be data dies 405. For example, the data bits of the new codeword (which were previously stored in the failed memory dies) may be written to die 9, die 10, die 19, and die 20. Thus, die 9, die 10, die 19, and die 20 may “replace” the failed memory dies for storing the data bits of the codeword. Although re-purposing the parity dies 410 reduces the quantity of parity dies 410, the memory system still has capacity to store the parity bits for the new codeword because the quantity of new parity bits (e.g., 32B) associated with the DDDC ECC scheme is less than the quantity of parity bits (e.g., 64B) associated with the QDDC ECC scheme. So, the memory system may write the parity bits for the new codeword to die 9, die 10, die 19, and die 20. Accordingly, the data bits of the new codeword may be stored across thirty-two memory dies and the parity bits of the codeword may be stored across four memory dies.

Because the new codeword is protected by the DDDC ECC scheme, the memory system is able to correct for two more die-level failures, bringing the total quantity of die-level failure corrections to six (effectively enabling a 6DDC ECC scheme). For example, if die 1 and die 22 fail, the memory system may use the DDDC ECC scheme to correct the data bits of the codeword that are stored in die 1 and die 22. Thus, the first technique may enable ECC coverage extension by allowing the memory system to correct six die-level failures even though the memory system is configured with a QDDC ECC scheme.

In some examples, after correcting for six die-level failures, the memory system may generate an SDDC codeword from the corrected data bits of the new codeword. For example, the memory system may apply the SDDC ECC scheme to the corrected data bits to generate an SDDC codeword that has 256B of data and 16B of parity. In such examples, the memory system may correct the codeword data bits from the newly failed dies (e.g., die 1, die 22) using the DDDC ECC scheme, generate a new codeword protected by the SDDC ECC scheme, and write the corrected data bits of the newest (SDDC-protected) codeword (e.g., the data bits from die 1 and die 22) to re-purposed parity dies 410 (e.g., die 29, die 30). Accordingly, the data bits (e.g., 256B) of the newest (SDDC-protected) codeword may be stored across thirty-two memory dies and the parity bits (e.g., 16B) of the newest codeword may be stored across two memory dies. Because the new codeword is protected by the SDDC ECC scheme, the memory system is able to correct for another die-level failure, bringing the total quantity of die-level failure corrections to seven (effectively enabling a 7DDC ECC scheme).

Thus, the first technique described herein can be used to enable the correction of more than four die-level failures even though the memory system is configured with a QDDC ECC scheme.

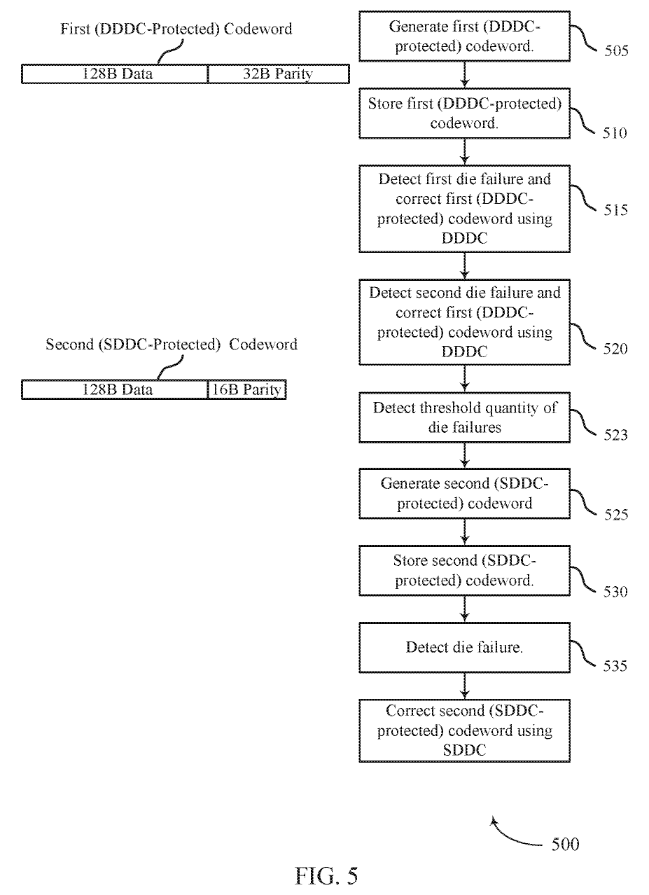

FIG. 5 shows an example of a process flow 500 that supports ECC coverage extension in a memory system in accordance with examples as disclosed herein. The process flow 500 may be an example of the first technique employed by a memory system as described herein. To aid in understanding, the process flow 500 is described in the context of the storage configuration 300 illustrated in FIG. 3. The process flow 500 may enable correction of three die-level failures using a combination of DDDC and SDDC ECC schemes. However, aspects of the process flow 500 may be used to enable any quantity of die-level failures using different combinations of codeword-level ECC schemes.

At 505, the memory system may generate a first codeword that is protected by a first codeword-level ECC scheme (e.g., a DDDC ECC scheme). For example, the memory system may use the DDDC ECC scheme to generate a first set of parity bits for a set of data bits and may combine the first set of parity bits with the set of data bits to form the first codeword. In some examples, the first codeword may have 128B of data and 32B of parity.

At 510, the memory system may store the first codeword across multiple memory dies. For example, as part of writing the set of data bits to the sixteen data dies 305, the memory system may write a subset of the data bits to die 14 and a subset of the data bits to die 16. The memory system may also write the first set of parity bits to the four parity dies 310.

At 515, the memory system may detect a first memory die failure (e.g., die 14) and correct the first codeword based on the detection. For example, the memory system may read the subsets of the data bits of the codeword from die 14, read the first set of parity bits from the parity dies 310, and apply the DDDC ECC scheme to decode and correct the first codeword. The memory system may then write the once-corrected first codeword back to the memory dies.

At 520, the memory system may detect a second memory die failure (e.g., die 16) and correct the first codeword based on the detection. For example, the memory system may read the subsets of the data bits of the codeword from die 16, read the first set of parity bits from the parity dies 310, and apply the DDDC ECC scheme to decode and correct the first codeword. The memory system may then write the twice-corrected first codeword back to the memory dies. Thus, after 520, the memory system may have performed two codeword-level corrections.

At 523, the memory system may determine that a threshold quantity of memory dies have failed. For example, the memory system may determine that the quantity of failed memory dies (e.g., two) is equal to the quantity of die-level failures (e.g., two) that first codeword-level ECC scheme is capable of correcting. Continuing the example from FIG. 3, the memory system may determine, based on die 14 and die 16 failing, that the threshold quantity of failed dies has been satisfied.

At 525, the memory system may generate a second codeword that is protected by a second codeword-level ECC scheme (e.g., a SDDC ECC scheme). For example, the memory system may use the SDDC ECC scheme to generate a second set of parity bits for the set of data bits and may combine the second set of parity bits with the set of data bits to form the second (SDDC-protected) codeword. The data bits of the second codeword may be the same as the data bits of the first codeword and thus may include the corrected subsets of data bits read from die 14 and die 16. However, the second set of parity bits may be different from the first set of parity bits due to the use of different codeword-level ECC schemes. So, in some examples, the second codeword may have 128B of data and 16B of parity. Reducing the quantity of parity bits used to protect the second codeword may allow the memory system to fit the second codeword in memory even though two memory dies have failed.

At 530, the memory system may store the second codeword across the memory dies. As part of writing the set of data bits of the second codeword to the memory dies, the memory system may write a subset of the data bits (e.g., the subset of data bits read from die 14) to die 9 and may write a subset of the data bits (e.g., the subset of data bits read from die 16) to die 10. The memory system may also write the second set of parity bits to the remaining two parity dies 310 (e.g., die 19, die 20).

At 535, the memory system may detect a third die-failure. For example, the memory system may determine that die 2 has failed. Accordingly, at 540, the memory system may perform a third codeword-level correction. For example, the memory system may correct the second codeword. To do so, the memory system may read the data bits of the second codeword (including the subsets of the data bits in die 9 and die 10) from the memory dies (including die 9, die 10), read the second set of parity bits from the parity dies 310 (e.g., die 19, die 20), and apply the SDDC ECC scheme to decode and correct the second codeword.

Thus, the memory system may implement aspects of the process flow 500 to increase the ECC coverage of the memory system.

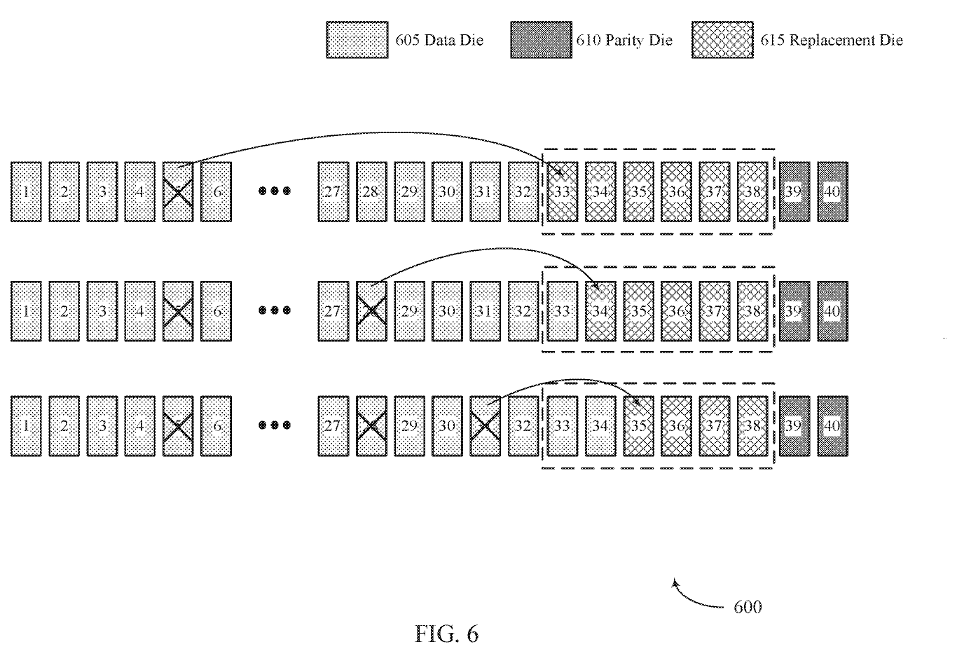

FIG. 6 shows an example of memory dies 600 that support ECC coverage extension in a memory system in accordance with examples as disclosed herein. The memory dies 600 may be included in a memory system such as a memory system 110 as described with reference to FIG. 1. The memory dies 600 may support the use of the second technique for extending ECC coverage. The memory dies 600 may store multiple codewords, each of which may be stored across multiple data dies 605 and parity dies 610. For example, the data bits of a SDDC-protected codeword may be stored across die 1 through die 32 and the parity bits of the SDDC-protected codeword may be stored across die 39 and die 40.

The memory dies 600 may include data dies 605, which may be selected for storing data (e.g., user data), parity dies 310, which may be selected for storing parity bits for a codeword-level ECC scheme, and replacement dies 615, which may be used in place of failed data dies 605. In some examples, the replacement dies 615 may be spare dies that are “empty” (e.g., store random data). In some examples, the replacement dies 615 may store user data. If the replacement dies 615 store user data, the memory system may distribute the user data among the non-failed data dies 605 before writing corrected data to the replacement dies 615.

The memory system that includes the memory dies 600 may be configured with a codeword-level ECC scheme such as a SDDC ECC scheme. However, the second technique may allow the memory system to correct for multiple die-level failures (e.g., up to the quantity of replacement dies).

For example, upon detecting that a first data die 605 (e.g., die 5) has failed, the memory system may read the data from the first data die 605 and correct the data using the SDDC ECC scheme and the parity bits for the data. On the codeword level, for a first codeword, the memory system may read the data bits of the first codeword from the memory dies (including a first subset of data bits of the first codeword from the first data die 605) and correct the first codeword using the SDDC ECC scheme and the parity bits for the first codeword. For a second codeword, the memory system may read the data bits of the second codeword from the memory dies (including a first subset of data bits of the second codeword from the first data die 605) and correct the second codeword using the SDDC ECC scheme and the parity bits for the second codeword. And so on and so forth for n codewords.

The memory system may then write the corrected data back to the memory dies. However, instead of writing the corrected first subset of data bits of the first codeword and the corrected first subset of data bits of the second codeword back to the first data die 605 (e.g., die 5), the memory system may write this data to a first replacement die 615 (e.g., die 33). So, the first and second codewords may remain protected by the SDDC ECC scheme even after correcting a die-level failure. If the first replacement die 615 already stores user data, the memory system may distribute the user data to the non-failed data dies 305 to make room for the corrected data in the first replacement die 615. After reading the data from the failed first data die 605 (e.g., die 5), the memory system may cease accessing the failed first data die 605.

Later, the memory system may detect that a second data die 605 (e.g., die 28) has failed. Based on the detection, the memory system may read the data from the second data die 605 and correct the data using the SDDC ECC scheme and the parity bits for the data. On the codeword level, for the first codeword, the memory system may read the data bits of the first codeword from the memory dies (including a second subset of the data bits of the first codeword from the second data die 605) and correct the first codeword using the SDDC ECC scheme and the parity bits for the first codeword. For the second codeword, the memory system may read the data bits of the second codeword from the memory dies (including a second subset of the data bits of the second codeword from the second data die 605) and correct the second codeword using the SDDC ECC scheme and the parity bits for the second codeword. And so on and so forth for n codewords.

The memory system may then write the corrected data back to the memory dies. However, instead of writing the corrected second subset of data bits of the first codeword and the corrected second subset of data bits of the second codeword to the second data die 605 (e.g., die 28), the memory system may write this data to a second replacement die 615 (e.g., die 34). So, the first and second codewords may remain protected by the SDDC ECC scheme even after correcting a second die-level failure. If the second replacement die 615 already stores user data, the memory system may distribute the user data to the non-failed data dies 305 to make room for the corrected data in the second replacement die 615. After reading the data from the failed second data die 605 (e.g., die 28), the memory system may cease accessing the failed second data die 605.

Later, the memory system may detect that a third data die 605 (e.g., die 31) has failed. Based on the detection, the memory system may read the data from the third data die 605 and correct the data using the SDDC ECC scheme and the parity bits for the data. On the codeword level, for the first codeword, the memory system may read the data bits of the first codeword from the memory dies (including a third subset of the data bits of the first codeword from the third data die 605) and correct the first codeword using the SDDC ECC scheme and the parity bits for the first codeword. For the second codeword, the memory system may read the data bits of the second codeword from the memory dies (including a third subset of data bits of the second codeword from the third data die 605) and correct the second codeword using the SDDC ECC scheme and the parity bits for the second codeword. And so on and so forth for n codewords.

The memory system may then write the corrected data back to the memory dies. However, instead of writing the corrected third subset of data bits of the first codeword and the corrected third subset of data bits of the second codeword to the third data die 605 (e.g., die 31), the memory system may write this data to a third replacement die 615 (e.g., die 35). So, the first and second codewords may remain protected by the SDDC ECC scheme even after correcting a third die-level failure. If the third replacement die 615 already stores user data, the memory system may distribute the user data to the non-failed data dies 305 to make room for the corrected data in the third replacement die 615. After reading the data from the failed third data die 605 (e.g., die 28), the memory system may cease accessing the failed third data die 605.

As more data dies 605 fail, the memory system may continue the replacement scheme until the memory system runs out of replacement dies 615. So, the quantity of die-level failure corrections the memory system is capable of performing may be equal to the quantity of replacement dies 615. In the given example, the memory system may be capable of performing seven die-level failure corrections (six replacements plus the SDDC parity correction) even though the memory system is configured with a SDDC ECC scheme.

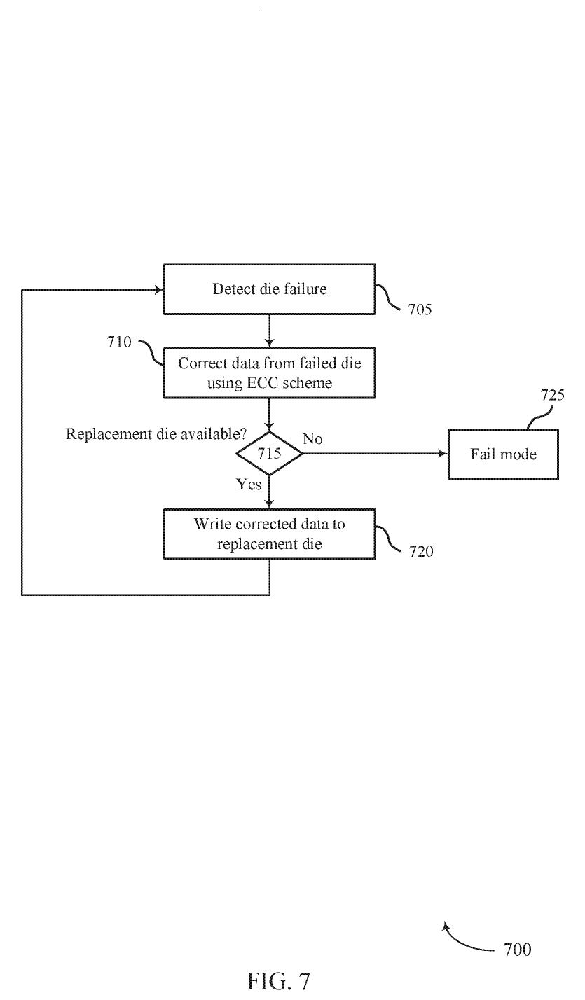

FIG. 7 shows an example of a process flow 700 that supports ECC coverage extension in a memory system in accordance with examples as disclosed herein. The process flow 700 may be an example of the second technique employed by a memory system as described herein. To aid in understanding, the process flow 700 is described in the context of the memory dies 600 illustrated in FIG. 6. The process flow 700 may enable correction of seven die-level failures using a SDDC ECC scheme. However, aspects of the process flow 700 may be used to enable n die-level failures using any power of codeword-level ECC scheme.

At 705, the memory system may detect a die failure. For example, the memory system may determine that a memory die (e.g., die 5) has failed. At 710, the memory system may, based on the memory die having failed, correct the data stored in the memory die. For example, the memory system may read the data from the memory die and apply a codeword- level ECC scheme. The data read from the memory die (and corrected by the ECC scheme) may include subsets of data bits for different codewords.

At 715, the memory system may determine whether a replacement die for storing the data is available. If a replacement die is not available, the memory system may enter a fail mode at 725. If a replacement die is available, the memory system may, at 720, write the corrected data from the failed memory die to the replacement die. The memory system may also erase the data in the failed die. In some examples (e.g., if the replacement) die stores user data that is redistributed to other data dies), the memory system may re-protect the corrected data by applying the ECC scheme before writing the corrected data to the replacement die. In some examples, the memory system may copy existing user data from the replacement die to one or more data dies 605 before writing the corrected data to the replacement die. After writing the corrected data to the replacement die, the memory system may then monitor for additional memory die failures.

Thus, the memory system may correct up to n+k die-level failures, where n is the quantity of replacement dies in the memory system and k is the quantity of codeword failures the codeword-level ECC scheme is capable of correcting.

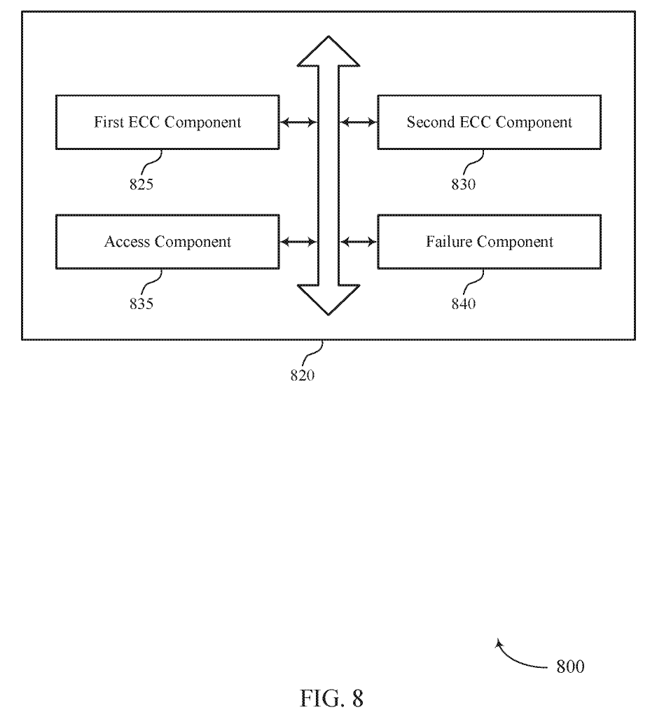

FIG. 8 shows a block diagram 800 of a memory system 820 that supports ECC coverage extension in a memory system in accordance with examples as disclosed herein. The memory system 820 may be an example of aspects of a memory system as described with reference to FIGS. 1 through 7. The memory system 820, or various components thereof, may be an example of means for performing various aspects of ECC coverage extension in a memory system as described herein. For example, the memory system 820 may include a first ECC component 825, a second ECC component 830, an access component 835, a failure component 840, or any combination thereof. Each of these components, or components of subcomponents thereof (e.g., one or more processors, one or more memories), may communicate, directly or indirectly, with one another (e.g., via one or more buses).

The first ECC component 825 may be configured as or otherwise support a means for correcting, using a first error correction code (ECC) scheme, data bits read from a first memory die that has failed, the data bits included in a first codeword protected by the first ECC scheme. The second ECC component 830 may be configured as or otherwise support a means for generating, using a second ECC scheme and after correcting the data bits using the first ECC scheme, a second codeword that includes the data bits based at least in part on the memory system having a threshold quantity of failed memory dies. The access component 835 may be configured as or otherwise support a means for writing the data bits of the second codeword that were previously stored in the first memory die to a second memory die previously used to store parity bits for the first codeword protected by the first ECC scheme.

In some examples, the first ECC component 825 may be configured as or otherwise support a means for correcting, using the first ECC scheme, second data bits read from a third memory die that has failed, where the second data bits are included in the first codeword protected by the first ECC scheme, and where the second codeword includes the second data bits. In some examples, the access component 835 may be configured as or otherwise support a means for writing the second data bits of the second codeword to a fourth memory die previously used to store second parity bits for the first codeword.

In some examples, the second ECC scheme is capable of correcting fewer die-level failures than the first ECC scheme. In some examples, the first ECC scheme includes a Dual Die Data Correction (DDDC) ECC scheme configured to correct two die-level failures. In some examples, the second ECC scheme includes a Single Die Data Correction (SDDC) ECC scheme configured to correct a single die-level failure. In some examples, the first ECC scheme includes a Quad Die Data Correction (QDDC) ECC scheme configured to correct four die-level failures. In some examples, the second ECC scheme includes a Dual Die Data Correction (DDDC) ECC scheme configured to correct two die-level failures.

In some examples, the access component 835 may be configured as or otherwise support a means for writing second parity bits, generated based at least in part on the data bits using the second ECC scheme, to a third memory die, where the second codeword includes the second parity bits.

In some examples, the failure component 840 may be configured as or otherwise support a means for determining that a third memory die storing second data bits of the first codeword has failed. In some examples, the second ECC component 830 may be configured as or otherwise support a means for correcting, using the second ECC scheme, the second data bits of the first codeword based at least in part on determining that the third memory die has failed.

In some examples, the access component 835 may be configured as or otherwise support a means for writing the data bits to the first memory die before failure of the first memory die, where the data bits are corrected after storage in the first memory die. In some examples, the access component 835 may be configured as or otherwise support a means for writing the parity bits for the first codeword to the second memory die before failure of the first memory die, where the data bits are corrected based at least in part on reading the parity bits from the second memory die.

In some examples, the first ECC component 825 may be configured as or otherwise support a means for correcting, using an error correction code (ECC) scheme, a first set of data bits read from a first memory die that has failed. In some examples, the access component 835 may be configured as or otherwise support a means for writing the first set of data bits to a second memory die based at least in part on the first memory die having failed. In some examples, the first ECC component 825 may be configured as or otherwise support a means for correcting, using the ECC scheme after writing the first set of data bits to the second memory die, a second set of data bits read from a third memory die that has failed. In some examples, the access component 835 may be configured as or otherwise support a means for writing the second set of data bits to a fourth memory die based at least in part on the third memory die having failed.

In some examples, the second memory die includes a spare memory die that stores random data. In some examples, the fourth memory die includes a spare memory that stores random data.

In some examples, different subsets of the first set of data bits are included in different codewords each protected by the ECC scheme. In some examples, the first set of data bits and the second set of data bits are each included in a same codeword protected by the ECC scheme.

In some examples, the first set of data bits and the second set of data bits are each corrected based at least in part on a set of parity bits stored in a fifth memory die, the set of parity bits generated using the ECC scheme.

In some examples, the ECC scheme includes a Single Die Data Correction (SDDC) ECC scheme configured to correct a single die-level failure.

In some examples, the first ECC component 825 may be configured as or otherwise support a means for correcting, using the ECC scheme after writing the second set of data bits to the second memory die, a third set of data bits read from a fifth memory die that has failed. In some examples, the access component 835 may be configured as or otherwise support a means for writing the third set of data bits to a sixth memory die based at least in part on the fifth memory die having failed.

In some examples, the described functionality of the memory system 820, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 820, or various components thereof, may be implemented at least in part by instructions (e.g., stored in memory, non-transitory computer-readable medium) executable by such at least one processor.

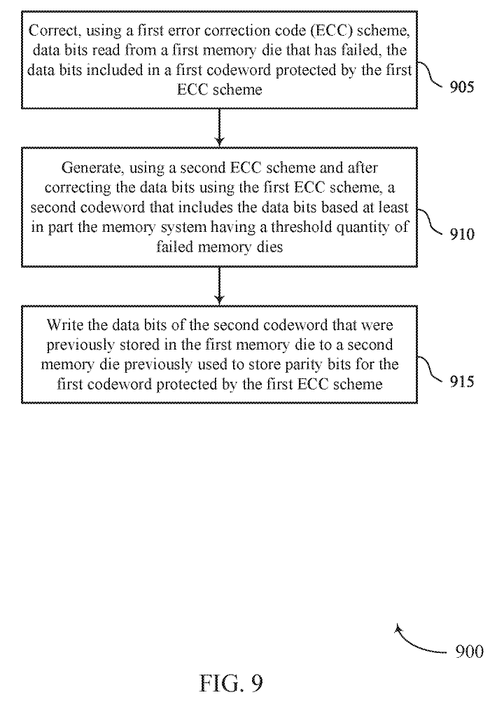

FIG. 9 shows a flowchart illustrating a method 900 that supports ECC coverage extension in a memory system in accordance with examples as disclosed herein. The operations of method 900 may be implemented by a memory system or its components as described herein. For example, the operations of method 900 may be performed by a memory system as described with reference to FIGS. 1 through 8. In some examples, a memory system may execute a set of instructions to control the functional elements of the device to perform the described functions. Additionally, or alternatively, the memory system may perform aspects of the described functions using special-purpose hardware.

At 905, the method may include correcting, using a first error correction code (ECC) scheme, data bits read from a first memory die (e.g., die 16 from FIG. 3) that has failed, the data bits included in a first codeword protected by the first ECC scheme. In some examples, aspects of the operations of 905 may be performed by a first ECC component 825 as described with reference to FIG. 8.

At 910, the method may include generating, using a second ECC scheme and after correcting the data bits using the first ECC scheme, a second codeword that includes the data bits based at least in part on the memory system having a threshold quantity of failed memory dies. In some examples, aspects of the operations of 910 may be performed by a second ECC component 830 as described with reference to FIG. 8.

At 915, the method may include writing the data bits of the second codeword that were previously stored in the first memory die to a second memory die (e.g., die 10 from FIG. 3) previously used to store parity bits for the first codeword protected by the first ECC scheme. In some examples, aspects of the operations of 915 may be performed by an access component 835 as described with reference to FIG. 8.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for correcting, using a first error correction code (ECC) scheme, data bits read from a first memory die that has failed, the data bits included in a first codeword protected by the first ECC scheme; generating, using a second ECC scheme and after correcting the data bits using the first ECC scheme, a second codeword that includes the data bits based at least in part on the memory system having a threshold quantity of failed memory dies; and writing the data bits of the second codeword that were previously stored in the first memory die to a second memory die previously used to store parity bits for the first codeword protected by the first ECC scheme.

Aspect 2: The method, apparatus, or non-transitory computer-readable medium of aspect 1, further including operations, features, circuitry, logic, means, or instructions, or any combination thereof for correcting, using the first ECC scheme, second data bits read from a third memory die that has failed, where the second data bits are included in the first codeword protected by the first ECC scheme, and where the second codeword includes the second data bits and writing the second data bits of the second codeword to a fourth memory die previously used to store second parity bits for the first codeword.

Aspect 3: The method, apparatus, or non-transitory computer-readable medium of any of aspects 1 through 2, where the second ECC scheme is capable of correcting fewer die-level failures than the first ECC scheme.

Aspect 4: The method, apparatus, or non-transitory computer-readable medium of aspect 3, where the first ECC scheme includes a Dual Die Data Correction (DDDC) ECC scheme configured to correct two die-level failures and the second ECC scheme includes a Single Die Data Correction (SDDC) ECC scheme configured to correct a single die-level failure.

Aspect 5: The method, apparatus, or non-transitory computer-readable medium of any of aspects 3 through 4, where the first ECC scheme includes a Quad Die Data Correction (QDDC) ECC scheme configured to correct four die-level failures and the second ECC scheme includes a Dual Die Data Correction (DDDC) ECC scheme configured to correct two die-level failures.

Aspect 6: The method, apparatus, or non-transitory computer-readable medium of any of aspects 1 through 5, further including operations, features, circuitry, logic, means, or instructions, or any combination thereof for writing second parity bits, generated based at least in part on the data bits using the second ECC scheme, to a third memory die, where the second codeword includes the second parity bits.

Aspect 7: The method, apparatus, or non-transitory computer-readable medium of any of aspects 1 through 6, further including operations, features, circuitry, logic, means, or instructions, or any combination thereof for determining that a third memory die storing second data bits of the first codeword has failed and correcting, using the second ECC scheme, the second data bits of the first codeword based at least in part on determining that the third memory die has failed.

Aspect 8: The method, apparatus, or non-transitory computer-readable medium of any of aspects 1 through 7, further including operations, features, circuitry, logic, means, or instructions, or any combination thereof for writing the data bits to the first memory die before failure of the first memory die, where the data bits are corrected after storage in the first memory die and writing the parity bits for the first codeword to the second memory die before failure of the first memory die, where the data bits are corrected based at least in part on reading the parity bits from the second memory die.

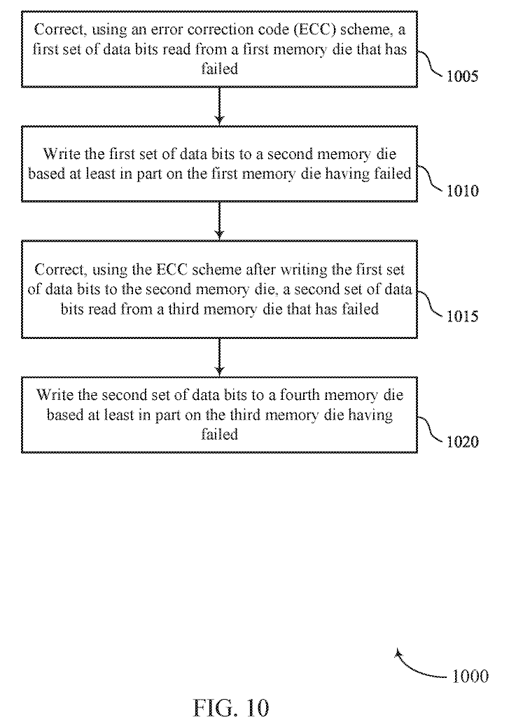

FIG. 10 shows a flowchart illustrating a method 1000 that supports ECC coverage extension in a memory system in accordance with examples as disclosed herein. The operations of method 1000 may be implemented by a memory system or its components as described herein. For example, the operations of method 1000 may be performed by a memory system as described with reference to FIGS. 1 through 8. In some examples, a memory system may execute a set of instructions to control the functional elements of the device to perform the described functions. Additionally, or alternatively, the memory system may perform aspects of the described functions using special-purpose hardware.

At 1005, the method may include correcting, using an error correction code (ECC) scheme, a first set of data bits read from a first memory die (e.g., die 5 from FIG. 6) that has failed. In some examples, aspects of the operations of 1005 may be performed by a first ECC component 825 as described with reference to FIG. 8.

At 1010, the method may include writing the first set of data bits to a second memory die (e.g., die 33 from FIG. 6) based at least in part on the first memory die having failed. In some examples, aspects of the operations of 1010 may be performed by an access component 835 as described with reference to FIG. 8.

At 1015, the method may include correcting, using the ECC scheme after writing the first set of data bits to the second memory die, a second set of data bits read from a third memory die (e.g., die 28 from FIG. 6) that has failed. In some examples, aspects of the operations of 1015 may be performed by a first ECC component 825 as described with reference to FIG. 8.

At 1020, the method may include writing the second set of data bits to a fourth memory die (e.g., die 34 from FIG. 6) based at least in part on the third memory die having failed. In some examples, aspects of the operations of 1020 may be performed by an access component 835 as described with reference to FIG. 8.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for correcting, using an error correction code (ECC) scheme, a first set of data bits read from a first memory die that has failed; writing the first set of data bits to a second memory die based at least in part on the first memory die having failed; correcting, using the ECC scheme after writing the first set of data bits to the second memory die, a second set of data bits read from a third memory die that has failed; and writing the second set of data bits to a fourth memory die based at least in part on the third memory die having failed.

Aspect 10: The method, apparatus, or non-transitory computer-readable medium of aspect 9, where the second memory die includes a spare memory die that stores random data and the fourth memory die includes a spare memory that stores random data.

Aspect 11: The method, apparatus, or non-transitory computer-readable medium of any of aspects 9 through 10, where different subsets of the first set of data bits are included in different codewords each protected by the ECC scheme.

Aspect 12: The method, apparatus, or non-transitory computer-readable medium of any of aspects 9 through 11, where the first set of data bits and the second set of data bits are each included in a same codeword protected by the ECC scheme.

Aspect 13: The method, apparatus, or non-transitory computer-readable medium of aspect 12, where the first set of data bits and the second set of data bits are each corrected based at least in part on a set of parity bits stored in a fifth memory die, the set of parity bits generated using the ECC scheme.

Aspect 14: The method, apparatus, or non-transitory computer-readable medium of any of aspects 9 through 13, where the ECC scheme includes a Single Die Data Correction (SDDC) ECC scheme configured to correct a single die-level failure.

Aspect 15: The method, apparatus, or non-transitory computer-readable medium of any of aspects 9 through 14, further including operations, features, circuitry, logic, means, or instructions, or any combination thereof for correcting, using the ECC scheme after writing the second set of data bits to the second memory die, a third set of data bits read from a fifth memory die that has failed and writing the third set of data bits to a sixth memory die based at least in part on the fifth memory die having failed.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method at a memory system, comprising:
correcting, using a first error correction code (ECC) scheme, data bits read from a first memory die that has failed, the data bits included in a first codeword protected by the first ECC scheme;
generating, using a second ECC scheme and after correcting the data bits using the first ECC scheme, a second codeword that includes the data bits based on the memory system having a threshold quantity of failed memory dies; and
writing the data bits of the second codeword that were previously stored in the first memory die to a second memory die previously used to store parity bits for the first codeword protected by the first ECC scheme.

2. The method of claim 1, further comprising:
correcting, using the first ECC scheme, second data bits read from a third memory die that has failed, wherein the second data bits are included in the first codeword protected by the first ECC scheme, and wherein the second codeword includes the second data bits; and
writing the second data bits of the second codeword to a fourth memory die previously used to store second parity bits for the first codeword.

3. The method of claim 1, wherein the second ECC scheme is capable of correcting fewer die-level failures than the first ECC scheme.

4. The method of claim 3, wherein the first ECC scheme comprises a Dual Die Data Correction (DDDC) ECC scheme configured to correct two die-level failures, and wherein the second ECC scheme comprises a Single Die Data Correction (SDDC) ECC scheme configured to correct a single die-level failure.

5. The method of claim 3, wherein the first ECC scheme comprises a Quad Die Data Correction (QDDC) ECC scheme configured to correct four die-level failures, and wherein the second ECC scheme comprises a Dual Die Data Correction (DDDC) ECC scheme configured to correct two die-level failures.

6. The method of claim 1, further comprising:
writing second parity bits, generated based on the data bits using the second ECC scheme, to a third memory die, wherein the second codeword includes the second parity bits.

7. The method of claim 1, further comprising:
determining that a third memory die storing second data bits of the first codeword has failed; and
correcting, using the second ECC scheme, the second data bits of the first codeword based on determining that the third memory die has failed.

8. The method of claim 1, further comprising:
writing the data bits to the first memory die before failure of the first memory die, wherein the data bits are corrected after storage in the first memory die; and
writing the parity bits for the first codeword to the second memory die before failure of the first memory die, wherein the data bits are corrected based on reading the parity bits from the second memory die.

9. A method at a memory system, comprising:
correcting, using an error correction code (ECC) scheme, a first set of data bits read from a first memory die that has failed;
writing the first set of data bits to a second memory die based on the first memory die having failed;
correcting, using the ECC scheme after writing the first set of data bits to the second memory die, a second set of data bits read from a third memory die that has failed; and
writing the second set of data bits to a fourth memory die based on the third memory die having failed.

10. The method of claim 9, wherein the second memory die comprises a spare memory die that stores random data, and wherein the fourth memory die comprises a spare memory that stores random data.

11. The method of claim 9, wherein different subsets of the first set of data bits are included in different codewords each protected by the ECC scheme.

12. The method of claim 9, wherein the first set of data bits and the second set of data bits are each included in a same codeword protected by the ECC scheme.

13. The method of claim 12, wherein the first set of data bits and the second set of data bits are each corrected based on a set of parity bits stored in a fifth memory die, the set of parity bits generated using the ECC scheme.

14. The method of claim 9, wherein the ECC scheme comprises a Single Die Data Correction (SDDC) ECC scheme configured to correct a single die-level failure.

15. The method of claim 9, further comprising:
correcting, using the ECC scheme after writing the second set of data bits to the second memory die, a third set of data bits read from a fifth memory die that has failed; and
writing the third set of data bits to a sixth memory die based on the fifth memory die having failed.

16. A memory system, comprising:
one or more memory devices; and
processing circuitry coupled with the one or more memory devices and configured to cause the memory system to:
correct, using a first error correction code (ECC) scheme, data bits read from a first memory die that has failed, the data bits included in a first codeword protected by the first ECC scheme;
generate, using a second ECC scheme and after correcting the data bits using the first ECC scheme, a second codeword that includes the data bits based on the memory system having a threshold quantity of failed memory dies; and
write the data bits of the second codeword that were previously stored in the first memory die to a second memory die previously used to store parity bits for the first codeword protected by the first ECC scheme.

17. The memory system of claim 16, wherein the processing circuitry is further configured to cause the memory system to:
correct, using the first ECC scheme, second data bits read from a third memory die that has failed, wherein the second data bits are included in the first codeword protected by the first ECC scheme, and wherein the second codeword includes the second data bits; and
write the second data bits of the second codeword to a fourth memory die previously used to store second parity bits for the first codeword.

18. The memory system of claim 16, wherein the second ECC scheme is capable of correcting fewer die-level failures than the first ECC scheme.

19. The memory system of claim 18, wherein:
the first ECC scheme comprises a Dual Die Data Correction (DDDC) ECC scheme configured to correct two die-level failures, and
the second ECC scheme comprises a Single Die Data Correction (SDDC) ECC scheme configured to correct a single die-level failure.

20. The memory system of claim 16, wherein the processing circuitry is further configured to cause the memory system to:
write second parity bits, generated based on the data bits using the second ECC scheme, to a third memory die, wherein the second codeword includes the second parity bits.

21. The memory system of claim 16, wherein the processing circuitry is further configured to cause the memory system to:
determine that a third memory die storing second data bits of the first codeword has failed; and
correct, using the second ECC scheme, the second data bits of the first codeword based on determining that the third memory die has failed.

22. The memory system of claim 16, wherein the processing circuitry is further configured to cause the memory system to:
write the data bits to the first memory die before failure of the first memory die, wherein the data bits are corrected after storage in the first memory die; and
write the parity bits for the first codeword to the second memory die before failure of the first memory die, wherein the data bits are corrected based on reading the parity bits from the second memory die.

23. A non-transitory computer-readable medium storing code, the code comprising instructions executable by one or more processors to cause a memory system to:
correct, using a first error correction code (ECC) scheme, data bits read from a first memory die that has failed, the data bits included in a first codeword protected by the first ECC scheme;
generate, using a second ECC scheme and after correcting the data bits using the first ECC scheme, a second codeword that includes the data bits based on the memory system having a threshold quantity of failed memory dies; and
write the data bits of the second codeword that were previously stored in the first memory die to a second memory die previously used to store parity bits for the first codeword protected by the first ECC scheme.

24. A memory system, comprising:
one or more memory devices; and
processing circuitry coupled with the one or more memory devices and configured to cause the memory system to:
correct, using an error correction code (ECC) scheme, a first set of data bits read from a first memory die that has failed;
write the first set of data bits to a second memory die based on the first memory die having failed;
correct, using the ECC scheme after writing the first set of data bits to the second memory die, a second set of data bits read from a third memory die that has failed; and
write the second set of data bits to a fourth memory die based on the third memory die having failed.

25. The memory system of claim 24, wherein, the second memory die comprises a spare memory die that stores random data, and wherein the fourth memory die comprises a spare memory that stores random data.

26. The memory system of claim 24, wherein different subsets of the first set of data bits are included in different codewords each protected by the ECC scheme.

27. The memory system of claim 24, wherein the first set of data bits and the second set of data bits are each included in a same codeword protected by the ECC scheme.

28. The memory system of claim 27, wherein the first set of data bits and the second set of data bits are each corrected based on a set of parity bits stored in a fifth memory die, the set of parity bits generated using the ECC scheme.

29. The memory system of claim 24, wherein the ECC scheme comprises a Single Die Data Correction (SDDC) ECC scheme configured to correct a single die-level failure.

30. The memory system of claim 24, wherein the processing circuitry is further configured to cause the memory system to:
correct, using the ECC scheme after writing the second set of data bits to the second memory die, a third set of data bits read from a fifth memory die that has failed; and
write the third set of data bits to a sixth memory die based on the fifth memory die having failed.
